(19) United States
(12) Patent Application Publication
(10) Pub. No.: US 2017/0249574 A1
(43) Pub. Date: Aug. 31, 2017

(54) SYSTEM FOR MONITORING OF WORKFLOWS CAPABLE OF AUTOMATIC TASK ALLOCATION AND MONITORING OF RESOURCES

(71) Applicant: A2PS Consulting and Software LLC, Albany, NY (US)

(72) Inventors: Daniel Knijnik, Old Greenwich, CT (US); Fabio Knijnik, Sao Paulo (BR); Anibal Knijnik, Porto Alegre (BR)

(21) Appl. No.: 15/442,702

(22) Filed: Feb. 26, 2017

Related U.S. Application Data
(60) Provisional application No. 62/300,390, filed on Feb. 26, 2016.

(51) Int. Cl. G06Q 10/06

(52) U.S. Cl. CPC G06Q 10/06313; G06Q 10/06314

(57) ABSTRACT

Disclosed herein is a system for efficient management of work flow through project management software. More specifically, the invention relates to novel task allocation processing based on available resources, characteristics of those resources, external event management, machine learning, and image processing ensuring efficient workflow by allowing resource capabilities to efficiently be utilized automatically.

### CROSS-REFERENCE TO RELATED APPLICATIONS

This application claims the benefit of U.S. Provisional Application No. 62/300,390, filed Feb. 26, 2016.

### FIELD OF THE INVENTION

The present invention relates generally to systems for monitoring and allocation of resources for complex project management. More specifically, the present invention relates to systems for monitoring and allocation of resources for complex project management that are capable of automatic task generation, allocation of resources to tasks, and monitoring of tasks progress and completion.

### BACKGROUND OF THE INVENTION

Project management is essential to facilitate timely delivery of products or services and to ensure efficient allocation of resources. Current solutions allow for visualization of project management but have limited functionality with respect to automation of tasks needed to complete a given project. Microsoft Project, for example, allows for the creation of tasks within a project but requires that each task needs to be manually entered by a user. Tasks are entered into in a spreadsheet form and displayed in a Gantt chart. Resources and characteristics of those resources are manually entered and assigned. Similarly, Enterprise Resource Planning, or ERP systems, such as SAP or Microsoft Dynamics require constant manual input from users as well. Such time spent manually entering tasks, manually allocating tasks to various resources, manually updating a project's progress, and manually collecting data on a resource's effectiveness leads to inefficient project management, can have a negative impact on a service provider's profitability, and does not add value to a client deliverable.

Existing project management solutions also do not allow for automatic analysis of the utilization of resources to control their utilization. If a resource is over utilized, budget constraints may make tasks cost prohibitive or render the resource ineffective all together. Conversely, if a resource is under utilized, profits are diminished and project completion can be delayed. In addition, improper utilization of resources makes a service provider less competitive and unable to take on additional projects. Microsoft Project and ERP systems, alike, allow for resources to be over utilized often leading to inadequate planning and inefficient use of resources. Through existing project management systems, project managers assign multiple tasks to a resource with no clear direction or priority. In addition, existing project management systems may allow a resource to be assigned to tasks with a low priority.

Existing project management systems also do not provide for automatically taking into account data concerning the characteristics of resources in planning and coordinating completion of tasks. In existing project management systems, such as Microsoft Project, any characteristics of resources must be manually entered each time, and data concerning these characteristics are static in the absence of manual user revision. Existing project management systems do not account for realities of changing characteristics of resources over time, or differentiation between resource reliability and quality within a given resource pool. Existing project management systems also do not allow for a resource's past performance to be automatically incorporated into resource allocation decisions for future tasks, and are not capable of automatically adjusting task allocation of a given project based on the historical performance of a resource on prior projects.

In addition, existing project management systems typically assume that projects are static, and are not responsive to a project's changing demands. For example, these existing systems do not account for changes during a project's undertaking, or “scope creep.” Existing project management systems are also limited in the types of data that they can receive, and from which sources they can receive data. In particular, existing project management systems require continual manual input of information, which is often not practical in fast-moving projects. In this way, existing project management systems are not capable of automatically updating adapting to meet the changes in circumstances or customer demands.

In view of the above, it would be beneficial to have a system for efficient project management that is capable of automatically managing tasks and resources, and minimizes the burden of manual coordination of tasks and input and the need for continuous user input. It would be further beneficial to have a system that automatically allocates tasks to resources in order to ensure proper utilization of resources. It would further be beneficial to have a system that automatically tracks and updates resource characteristics and learns resource characteristics over time, and incorporates revised data concerning resources in future task allocations. It would be further beneficial to have a system that collect data from networked data gathering tools, analyzes such data, and automatically adjusts schedules, task allocation, and project status based on such data.

### SUMMARY OF THE INVENTION

Disclosed herein is a project management system that is capable of automatic task generation for a project and automatic allocation of resources, and management of tasks and resources based on changes to task and resource characteristics and other variables, and which allows for automatic task generation, allocation of tasks, and efficient management of work flow. The system disclosed herein is capable of collecting feedback based on historical data and tracking variable resource characteristics, and applying machine learning algorithms in order to automatic the allocation of resources to tasks. In this way, the system avoids the need for manual task allocation. The system learns each resource's capability and customizes scheduling needs based on a resource's characteristics and availability.

According to an embodiment of the invention, a computer program product is provided that is embodied on a computer readable medium for processing project management information comprising: computer code for receiving from a plurality of sources a plurality of project data records; computer code for creating a set of tasks based on information contained in said project data records; computer code for determining a plurality of characteristics of a plurality of resources; computer code for correlating the set of tasks with the characteristics of said resources; and computer code for allocating a plurality of tasks from the set of tasks to the resources based on the characteristics of said resources.

In another related embodiment, the computer program product further comprises computer code for assigning a single task from the plurality of tasks allocated to a single resource from said resources.

In another related embodiment, the computer program product further comprises computer code computer code for restricting a single resource from said resources from performing a task based on a predetermined condition.

In another related embodiment, the computer program product further comprises computer code for automatically updating the plurality of characteristics of a resource based on the performance of said resource in a completing a task within the set of tasks.

In another related embodiment, the computer program product further comprises computer code for receiving an image processing file from a three dimensional camera.

In certain aspects, the computer program product further comprises computer code for updating the status of a task within the set of tasks based on receiving said image processing file.

In another related embodiment, the computer program product further comprises computer code for generating a new project data record based on the completion of the set of tasks by said resources.

In certain aspects, the computer program product further comprises computer code for storing the new project data record with said plurality of project data records.

In certain aspects, the computer program product further comprises computer code for generating predictive analytics for a future project based on the plurality of project data records, the new project data record, and characteristics of said resources.

In another related embodiment, the computer program product further comprises computer code for determining the need to retain or remove said resources or the need to acquire one or more new resources based on said set of tasks and characteristics of said resources.

In another related embodiment, the computer program product further comprises computer code for automatically updating the status of a project based on the performance a resource from said resources in a completing a task from the set of tasks.

In another related embodiment, the computer program product further comprises computer code for generating notifications to said resources when a resource completes a task from the set of tasks.

In another related embodiment, the computer program product further comprises computer code for generating rankings for said resources based on the characteristics of said resources.

In another embodiment, a project management system is provided for efficient management of workflow data among resources in one or more networks built on top of an underlying network, wherein the workflow data includes a plurality of projects and wherein the plurality of projects includes a plurality of tasks, the project management system comprising: a memory that stores (i) a plurality of project data records, and (ii) a plurality of characteristics of a plurality of resources; a project divider that separates a project into a set of tasks based on said project data records and the characteristics of said resources; a performance tracker that generates metrics from network traffic along the one or more overlay networks, including the completion of one or more tasks from the set of tasks in the project; a learning engine that continuously quantifies the characteristics of the resources based upon an analysis of the metrics; and a feedback loop that (i) generates a new project data record when the project is completed, (ii) stores said new project data record in said memory, and (iii) dynamically updates the characteristics of said resources.

In another related embodiment, the project divider assigns a single task from the set of tasks to a single resource within said resources.

In another related embodiment, the project divider restricts a single resource within said resources from performing a task based on a predetermined condition.

In another related embodiment, a three dimensional camera attached to the one or more overlay networks provides further metrics to the performance tracker.

In another related embodiment, the learning engine generates predictive analytics for future projects based on the project data records, the new project data record, and characteristics of said resources including the need to retain or remove said resources or the need to acquire one or more new resources.

In another related embodiment, the learning engine the learning engine generates rankings for said resources based on the characteristics of said resources.

In another embodiment, a system useful in a project manager planning projects is provided by efficiently managing work flow of a business, the system comprising: a cloud based database containing data, for each of a plurality of project data files, defining a plurality of tasks corresponding to the plurality of project data files, wherein each of the project data files includes a plurality of characteristics of a plurality of resources used to complete a project; a network enabled device for sending data, for each of a second plurality of resources, reporting on the status of a second plurality of tasks within a second project; and a computer server at the project manager, which computer server is coupled to the network enabled device and the cloud based database and programmed to: receive from the cloud based database the project data files; automatically allocate the second plurality of tasks to the second plurality of resources based on the project data files and a plurality of characteristics of the second plurality of resources; receive from the network enabled device, the status of the second plurality of tasks within the second project; and in response to the status of the second plurality of tasks being complete, automatically generate and transmit to the cloud based database a new project data file for the second project.

In another embodiment, a system comprising a project management component is provided comprising at least one hardware processor and configured to: automatically obtain a request for a project to be implemented; automatically define the project into a one or more tasks based, at least in part, on information from a different project, wherein the different project includes characteristic data of one or more resources; automatically determine a task allocation based on task requirements for the project, wherein the task requirements includes a deadline for task completion; automatically determine a period of time associated with the execution of the task by available production time of one or more resources, wherein the period of time is calculated for each available resource and is based, at least in part, on a current utilization of the available resource in relation to the remaining capacity of the available production time; exclude available resources when the determined period of time exceeds the deadline for task completion; automatically select a resource of the one or more resources based, at least in part on the task allocation and the period of time associated with the task; automatically cause the task to be implemented by the selected resource.

In another embodiment, system for determining an optimized sequence of workflow is provided by a first resource to a plurality of tasks: a non-transitory computer-readable storage medium; a processor configured by executing one or more software modules including instructions in the form of code stored in the storage medium, the modules including: a communication module that configures the processor to receive over a network from a remote device associated with the first resource, a plurality of task requirements to be completed by the first resource; a database module that configures the processor to store the plurality of task requirements to the storage medium, and wherein the database module further configures the processor to access a database including resource characteristics associated with a plurality of resources and a database including project data; a modeling module that configures the processor to generate one or more models for predicting resource performance for each of the plurality of task requirements using the resource characteristics associated with a plurality of resources and the project data; an analysis module that configures the processor to generate one or more ordered sequences of tasks to be completed by the first resource, wherein each of the one or more ordered sequences begins with the first resources' start time, ends with the first resource's end time, includes at least a portion of the plurality of task requirements, and wherein consecutive tasks in a ordered sequence define the availability of the first resource, wherein the analysis module further configures the processor to calculate a total duration for each of the one or more ordered sequences, wherein the total duration is calculated using the one or more models in view of the start time, and in view of the availability of the first resource as determined from a database of project data, and wherein the analysis module further configures the processor to identify based on the calculated total durations, an optimal ordered sequence from among the one or more ordered sequences, wherein the optimal ordered sequence has the lowest calculated total duration; and wherein the communication module further configures the processor to provide over a network to the remote device associated with the first resource, the optimal ordered sequence.

These and other aspects and advantages will become apparent to those of ordinary skill in the art by reading the following detailed description, with reference where appropriate to the accompanying drawings. Further, it should be understood that the foregoing summary is merely illustrative and is not intended to limit in any manner the scope or range of equivalents to which the appended claims are lawfully entitled.

### BRIEF DESCRIPTION OF THE DRAWINGS

The invention is described below in connection with the following illustrative figures, wherein:

FIG. 1 is a diagram depicting a schematic view of the system, its components and interactions, according to an embodiment of the invention; and

FIGS. 2a and 2b are visual comparisons between a domain model and CQRS model; and

FIG. 3 is a schematic view of a CQRS model; and

FIG. 4 is an illustration of an object diagram for a work model, according to an embodiment of the invention; and

FIG. 5 is an illustration of an object diagram for a HR model, according to an embodiment of the invention; and

FIG. 6 is an illustration of an object diagram for a workflow model, according to an embodiment of the invention; and

FIG. 7 is an illustration of a task creation webpage to be used by a project manager; and

FIG. 8 is an illustration of task scope webpage to be used by a project manager with a checklist of task items, according to an embodiment of the invention; and

FIG. 9 is an illustration of predecessors or tasks that need to be completed by a resource before another task is assigned being tracked in the system, according to an embodiment of the invention; and

FIG. 10 is an illustration of task alert after a task has been created according to an embodiment of the invention; and

FIGS. 11a and 11b are illustrations of a resource's time being allocated with tasks and any technical predecessors allocated to that resource, according to an embodiment of the invention; and

FIG. 12 is an illustration of a upcoming tasks, according to an embodiment of the invention; and

FIG. 13 is an illustration of the system displaying the statuses of various tasks, according to an embodiment of the invention; and

FIG. 14 is an illustration of the system displaying the rankings of various resources according to an embodiment of the invention; and

FIGS. 15a and 15b are an illustrative flowchart of interactions in the system, according to an embodiment of the invention; and

FIGS. 16a and 16b are illustrations of a three dimensional camera capturing changes at the location of a project, according to an embodiment of the invention.

### BRIEF DESCRIPTION OF THE DRAWINGS

The invention is described below in connection with the following illustrative figures, wherein:

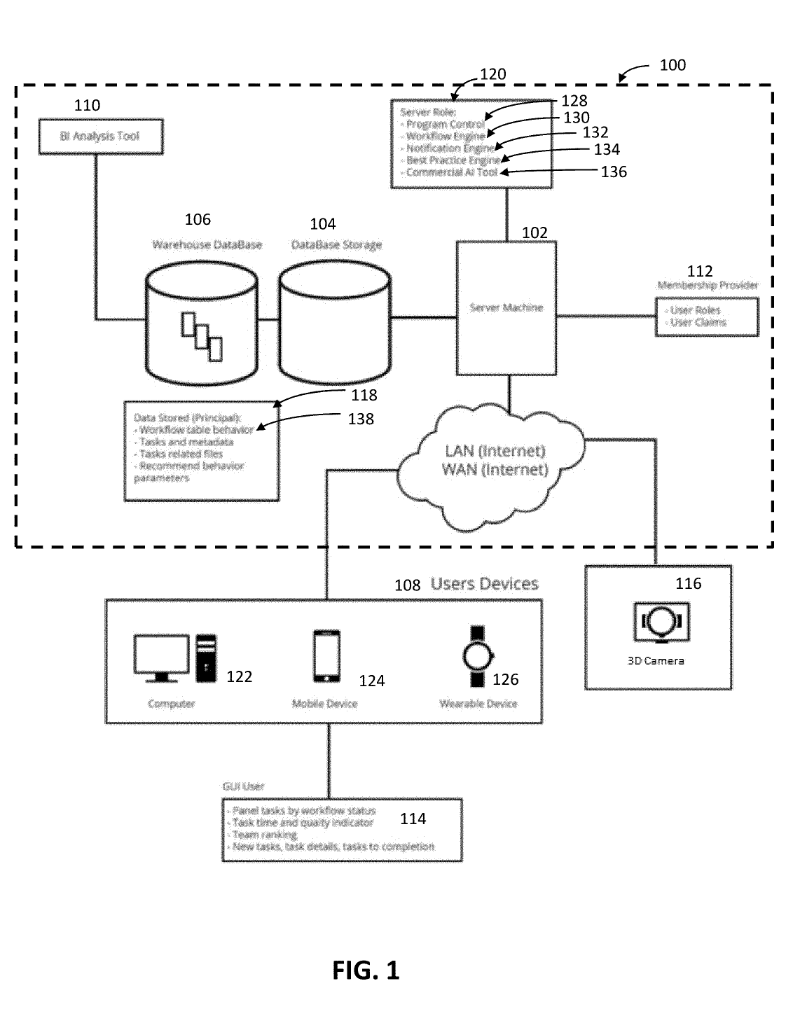

FIG. 1 is a diagram depicting a schematic view of the system, its components and interactions, according to an embodiment of the invention; and

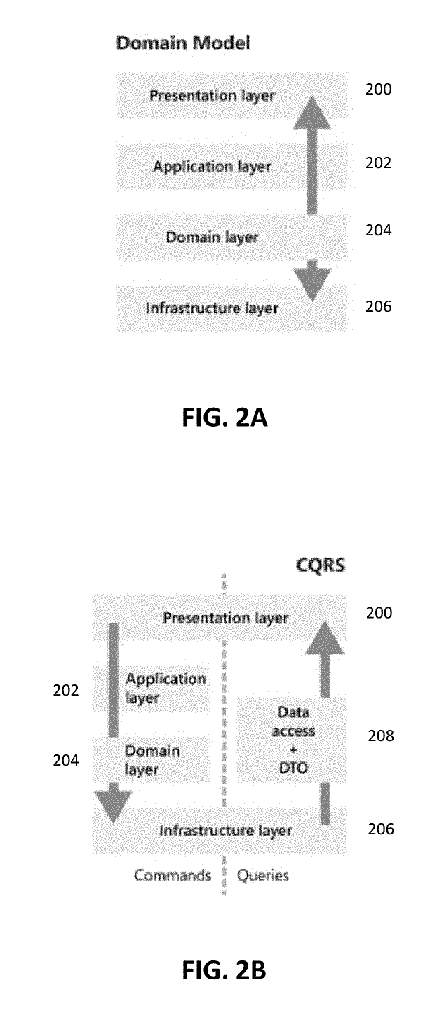

FIGS. 2a and 2b are visual comparisons between a domain model and CQRS model; and

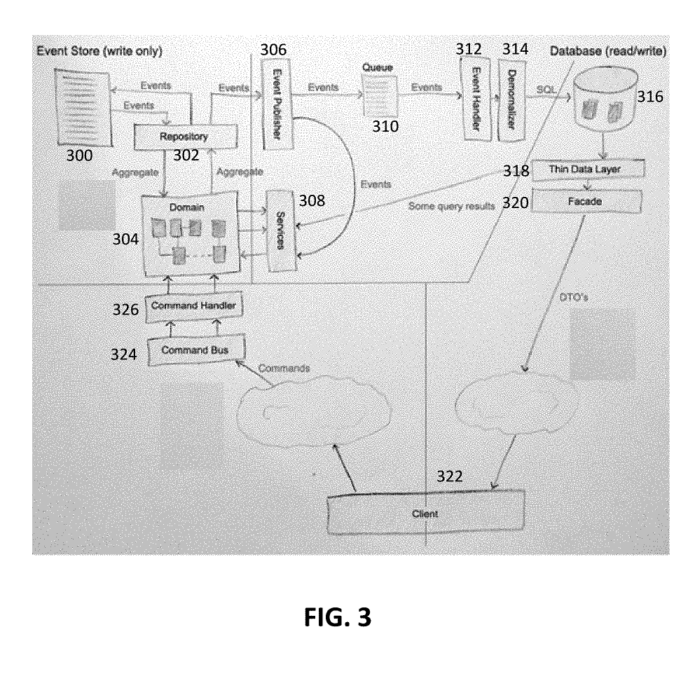

FIG. 3 is a schematic view of a CQRS model; and

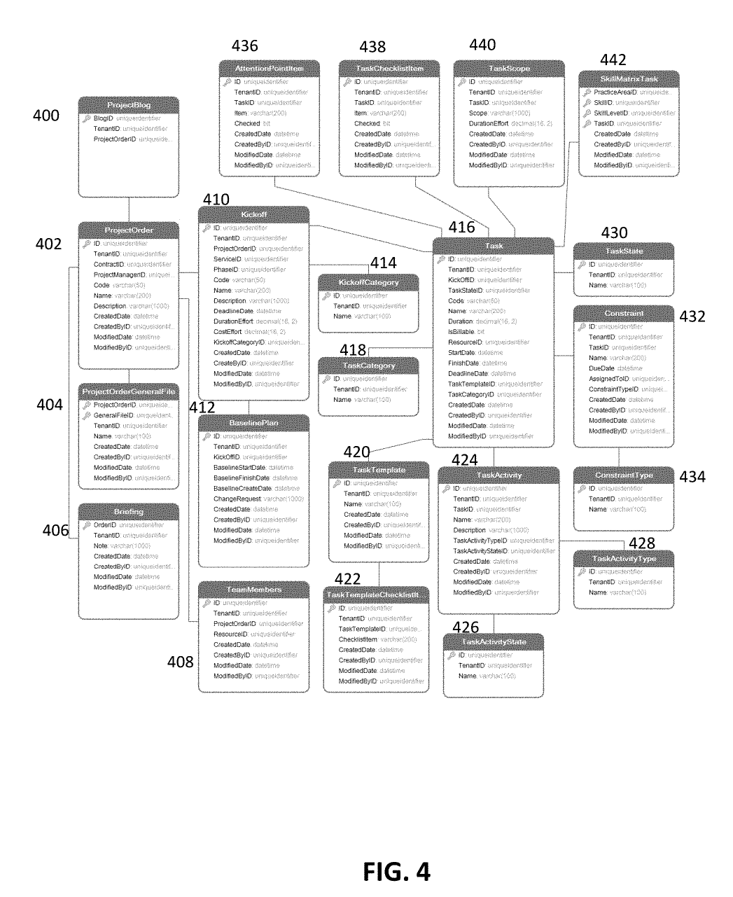

FIG. 4 is an illustration of an object diagram for a work model, according to an embodiment of the invention; and

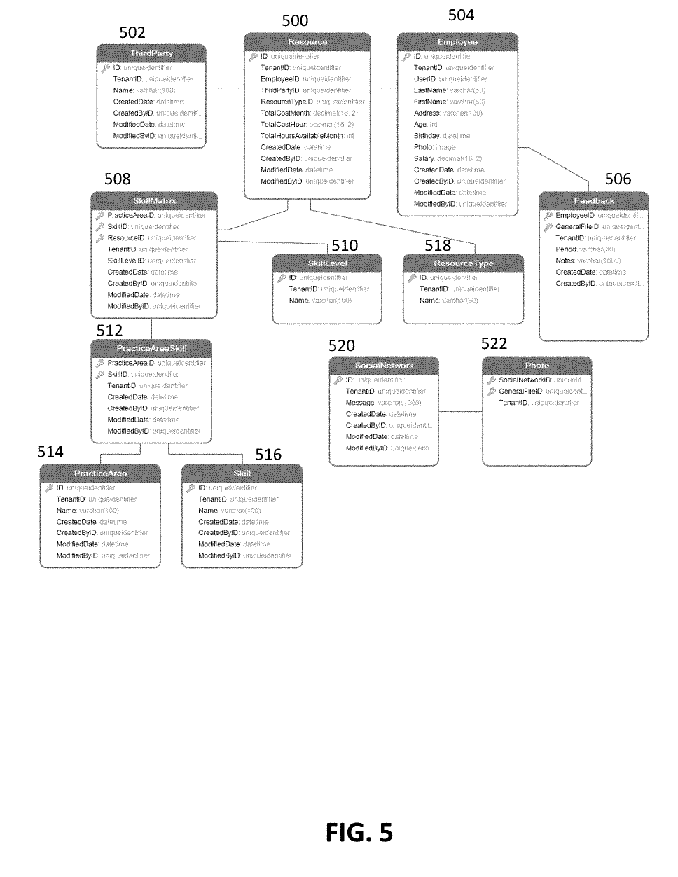

FIG. 5 is an illustration of an object diagram for a HR model, according to an embodiment of the invention; and

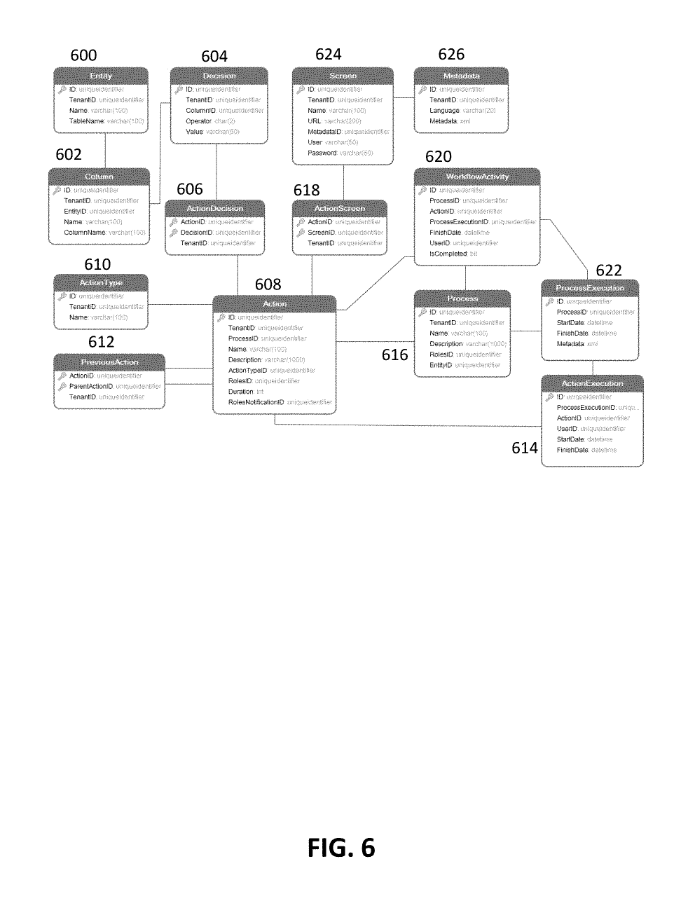

FIG. 6 is an illustration of an object diagram for a workflow model, according to an embodiment of the invention; and

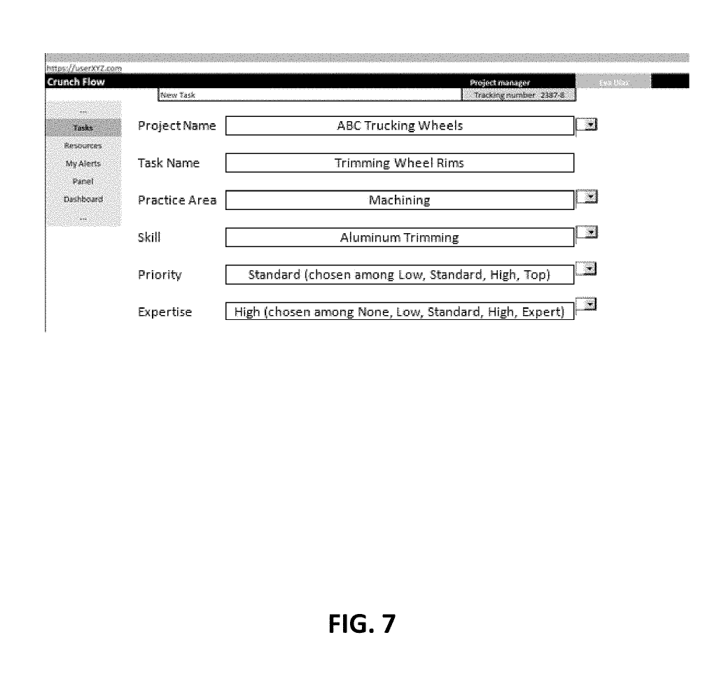

FIG. 7 is an illustration of a task creation webpage to be used by a project manager; and

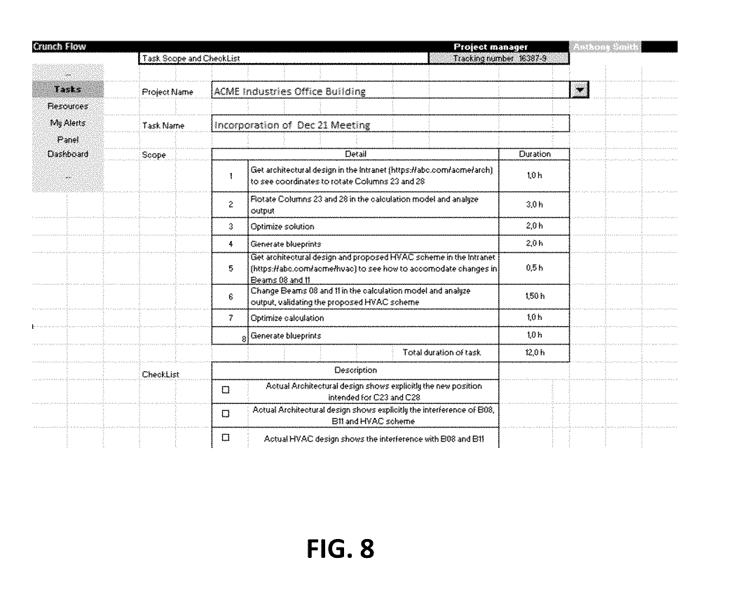

FIG. 8 is an illustration of task scope webpage to be used by a project manager with a checklist of task items, according to an embodiment of the invention; and

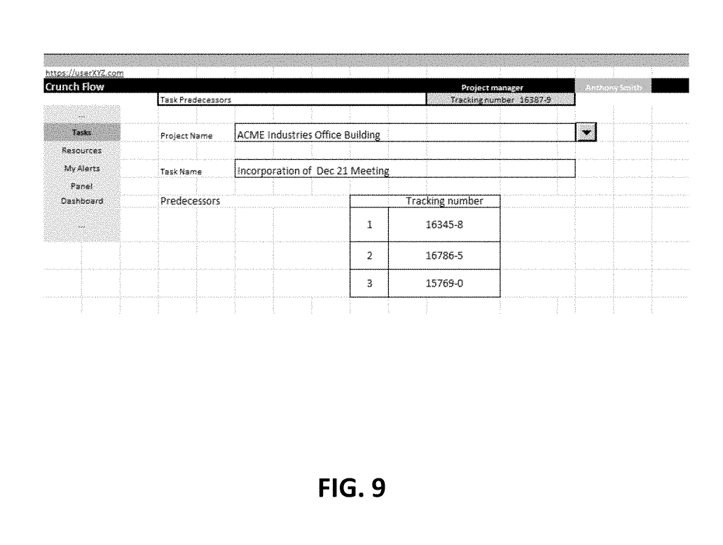

FIG. 9 is an illustration of predecessors or tasks that need to be completed by a resource before another task is assigned being tracked in the system, according to an embodiment of the invention; and

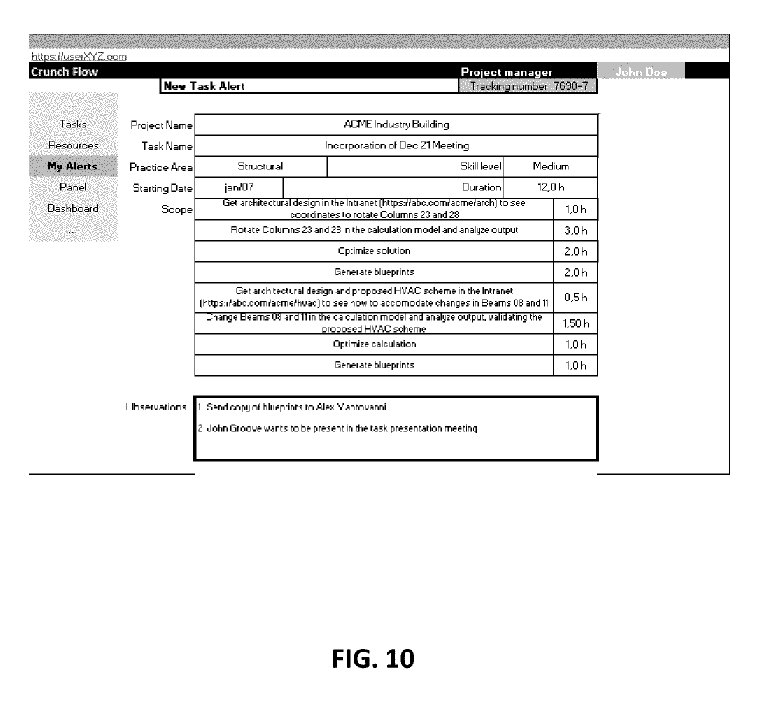

FIG. 10 is an illustration of task alert after a task has been created according to an embodiment of the invention; and

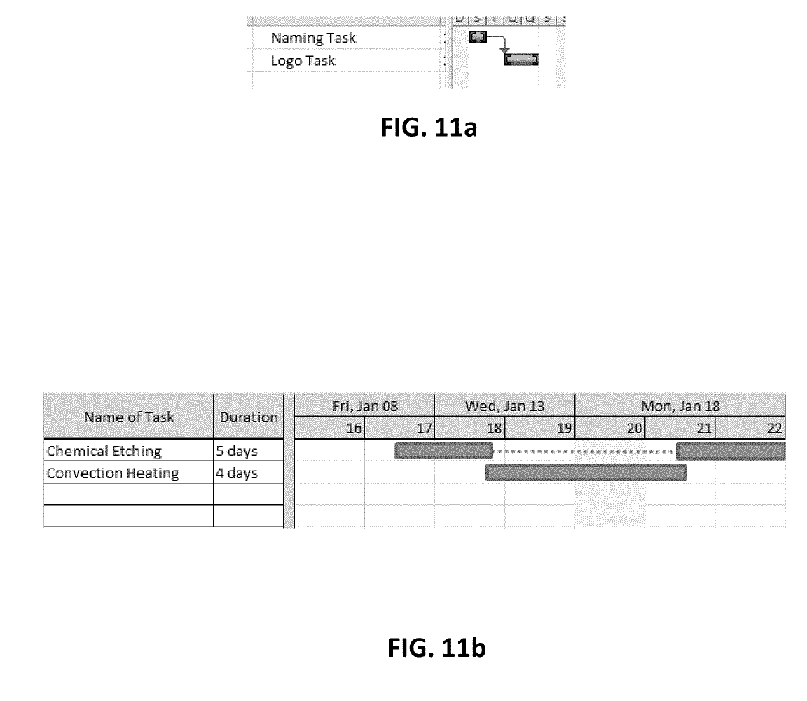

FIGS. 11a and 11b are illustrations of a resource's time being allocated with tasks and any technical predecessors allocated to that resource, according to an embodiment of the invention; and

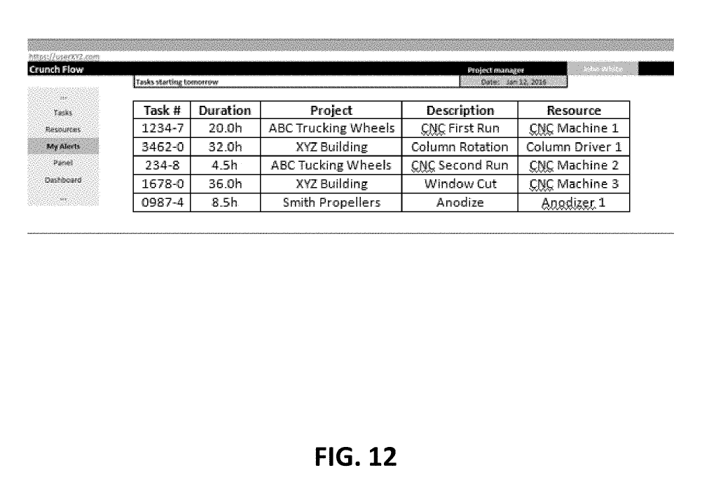

FIG. 12 is an illustration of a upcoming tasks, according to an embodiment of the invention; and

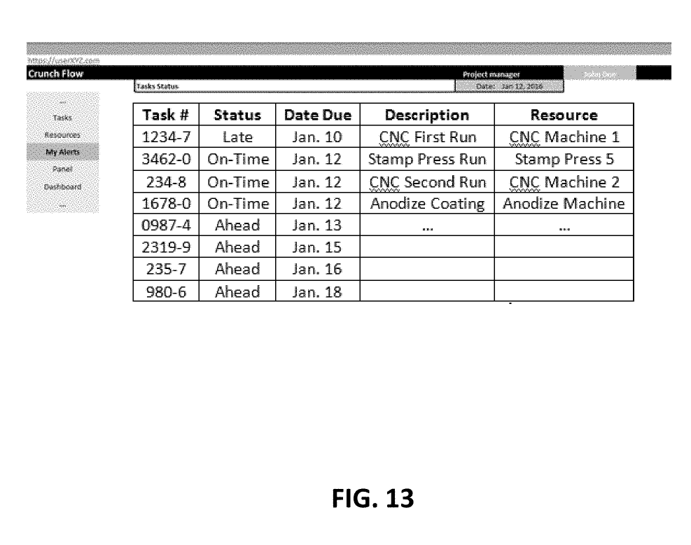

FIG. 13 is an illustration of the system displaying the statuses of various tasks, according to an embodiment of the invention; and

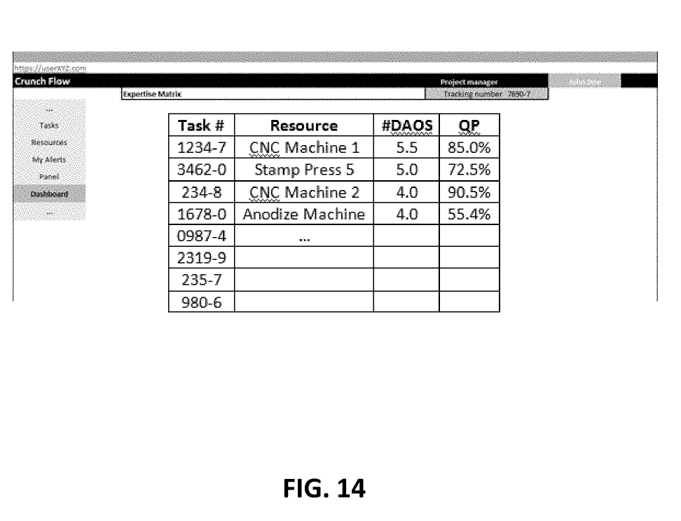

FIG. 14 is an illustration of the system displaying the rankings of various resources according to an embodiment of the invention; and

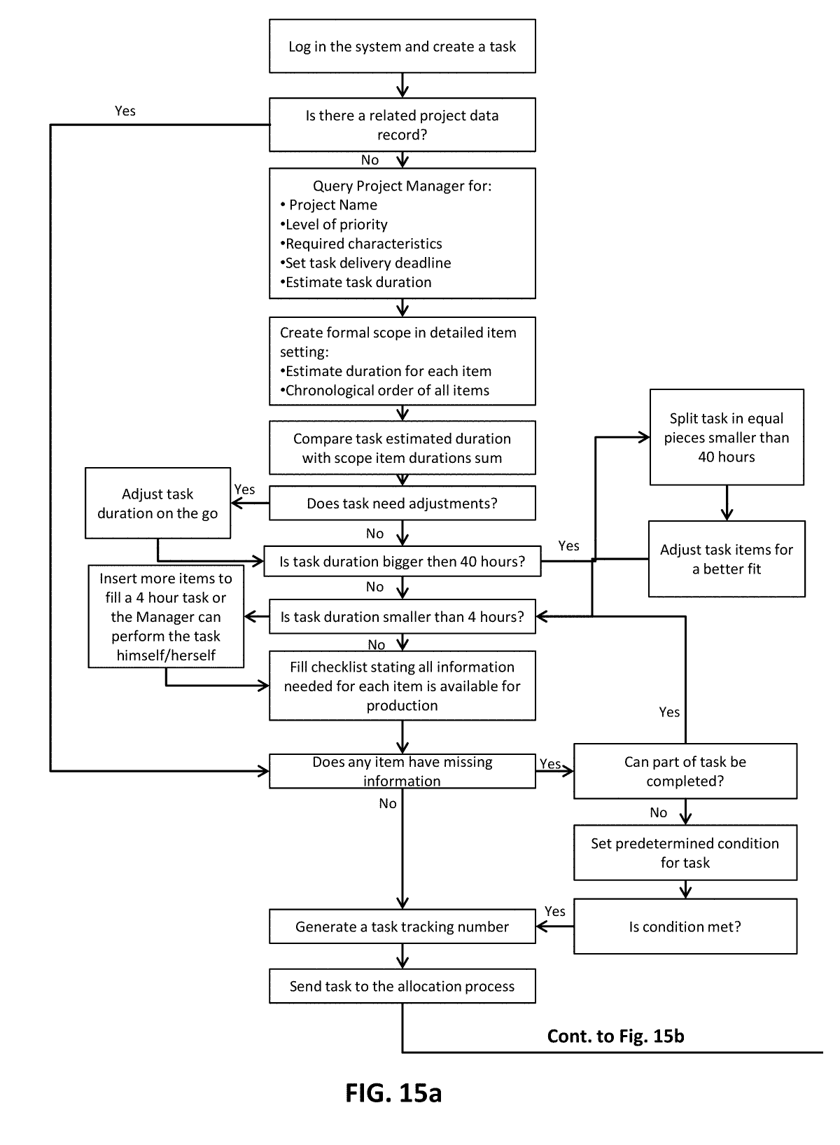

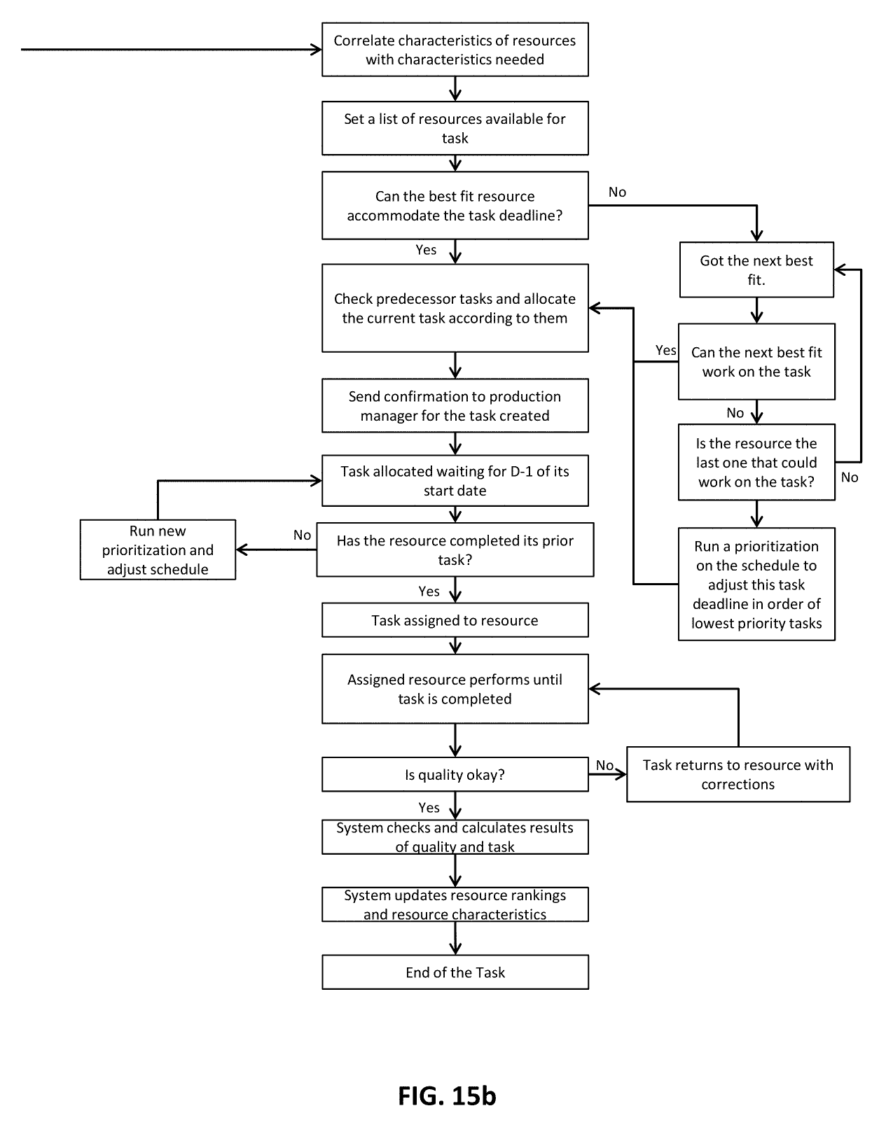

FIGS. 15a and 15b are an illustrative flowchart of interactions in the system, according to an embodiment of the invention; and

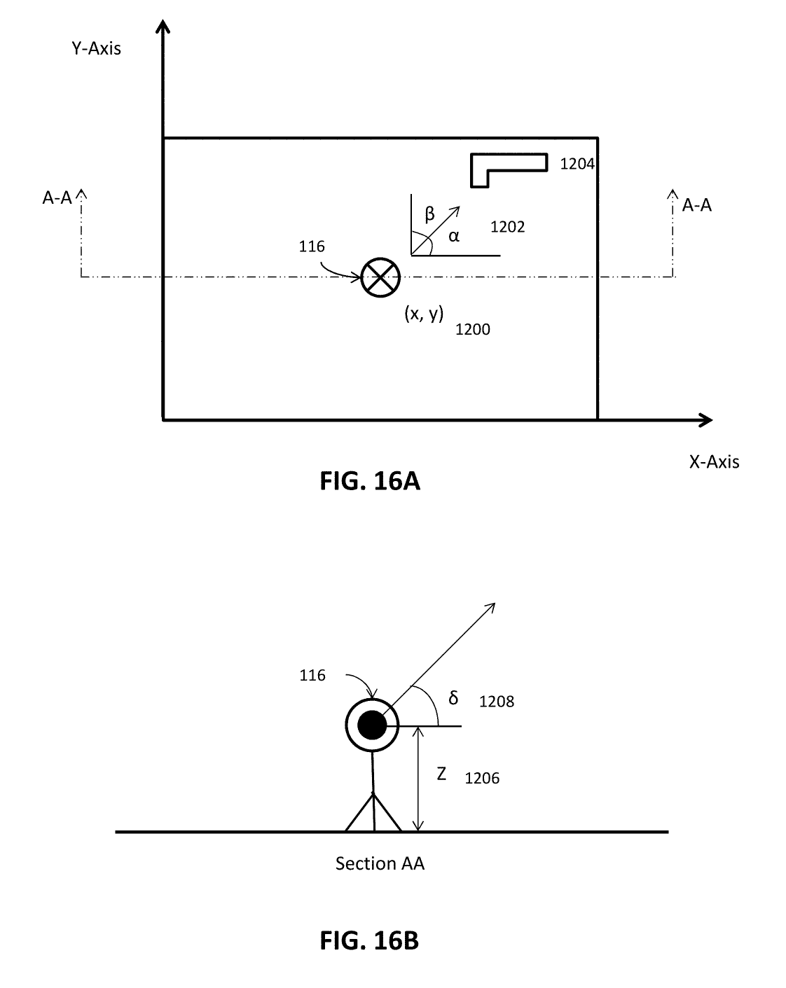

FIGS. 16a and 16b are illustrations of a three dimensional camera capturing changes at the location of a project, according to an embodiment of the invention.

### DETAILED DESCRIPTION

While the present invention is capable of being embodied in various forms, for simplicity and illustrative purposes, the principles of the invention are described in part by referring to several embodiments thereof. It is understood, however, that the present disclosure is to be considered as an exemplification of the claimed subject matter, and is not intended to limit the appended claims to the specific embodiments illustrated. It will be apparent to one of ordinary skill in the art that the invention may be practiced without limitation to these specific details. In other instances, well-known methods and structures have not been described in detail so as not to unnecessarily obscure the invention.

FIG. 1 shows a system 100 according to a first embodiment of the invention. The system 100 includes a server machine 102, database storage 104, data warehouse 106, workflow engine 120, notification engine 120, a graphical user interface (GUI) presenter 114, and an artificial intelligence (AI) subsystem [ ]. Each of these system components resides in a networked “cloud” system and communicates with other system components via TCP/IP or other standard networking communication protocols, may reside in a single server. Alternatively, these components may be housed in a single server or network of servers. The server machine 102 communicates to one or more user devices 108, which may take the form of a personal computer 122, mobile device 124, or wearable device 126. The system may be implemented in an intranet scenario, wherein which the server machine 102 communicates to the user devices via a large area network (LAN). Alternatively, and preferably, the system is implemented in an Internet scenario, wherein which the server machine 102 communicates to the user devices 108 via a wide area network (WAN), such as the Internet.

The user devices have a display capable of displaying a graphical user interface (GUI), which is provided to the user device by the server machine 102 and which permits users to provide data for use or storage by the system; receive alerts, notifications, requests for data, and other information from the system 100; and otherwise interact with the system 100. According to a preferred embodiment, the server machine 102 has an administration subsystem that requires a user to undergo an authentication process (or log in process) in order to access the system 100. For example, the server machine 102 may prompt the user via the GUI on the user device 108 to provide a username and password, which the server machine 102 may then use to verify that the user is an authorized user of the system 100. The authentication process of the server machine 102 stores in the database storage 104 information corresponding to a user's access of the system, which are used for security and audit purposes. A user's authentication information, such as the user's username, are associated with certain credentials (or user roles) which the server machine 102 utilizes to determine the extent to which a particular user is able to control or access certain functions of the system 100. The user device 108 also includes audio output in order to receive audible alerts from the system 100.

The program controller 128 in the server machine 120 coordinates readings of the database storage 104 and warehouse database 106 through the use of a machine learning engine, which may be based upon a commercial artificial intelligence (AI) tool 136. The machine learning engine monitors inputs to the system and monitors associations between inputs at all times. The machine learning tool also receives and executes pre-defined rules customized for the creation of system objects (e.g., projects, tasks, resources) and variables associated with those objects, and the execution and association of objects with one another, such as, for example, the task allocation process. These pre-determined rules may be continuously improved by experts to create best practices with the assistance of the machine learning engine. The machine learning engine analyzes data corresponding to the input and creation of tasks and the results thereof, and identifies associations between inputs and positive results. The results of this analysis and identification are stored by the machine learning engine as optimized parameters (also referred to as recommended behavior parameters) for each action taken by a user in connection with the project management system (e.g., the task generation or task allocation actions). When a user executes any action within the system, the program controller 128 in the server machine 120 runs a best practice engine 134 that searches the database storage 104 for the optimized parameters generated and stored by the machine learning engine. The best practices engine 134 reads the optimized parameters from the database storage 104 and displays such parameters on the GUI of the user device as recommended best practices for a particular action. Alternatively, a user may utilize the GUI to call up an action “wizard” for a particular action, which causes the system to invoke the best practices engine and provide optimized parameters for the action.

The machine learning engine is also capable of generating information for use with forecasting and optimizing decisions (including allocation of tasks). The system databases 106, 104 contain all relevant information pertaining to the tasks that have been and are to be performed, how the tasks were performed, and by what resources the tasks were performed and managed. The machine learning engine is capable of analyzing this information to develop associations between the information and generate forecasts corresponding to, among other things, task completion, resource utilization, and financial inlays and outlays. As additional information is provided to the system, the machine learning engine continually updates and improves its ability to forecast what is likely to happen with respect to the selection of a particular parameter for a particular action (e.g., the assignment of a particular resource to a particular task), and can therefore determine, for example, the best resources to allocate for each task, which resources are likely to work best together for completion of a particular task, how long each kind of engagement, project, or task will take, and forecast demand for services and sales.

Each of the areas of functionality and features may be implemented in software by various modules according to a domain drive development architecture standard, wherein separate domains are established according to different objectives. For example, a first domain may correspond to software for the provider of a system as shown in FIG. 1, and a second domain may correspond to software that implements system 100 (as described herein) and which is intended for the user of the system shown in FIG. 1. Each of these domains may include several bounded contexts, which correspond to distinct areas of functionality. For example, the system 100 includes the following contexts described in detail herein: a work management bounded context that corresponds to project and task creation and management, a resources bounded context that corresponds to the various resources available to complete tasks, and a workflow bounded context that corresponds to the actions and decisions needed to execute a workflow. The system described herein may further incorporate additional functionality and features not shown in FIG. 1 for the user of the workflow management system 100, such as client internal administrative applications, sales management, financial management, NPS customer satisfaction, electronic content management, and risk management.

Each bounded context may be implemented in software and hardware according to a create, read, update and delete (CRUD) model or according to a create and query responsibility segregation/event sourcing (CQRS/ES) model, which differs from the CRUD model in that it separates the responsibilities of recording and database reading and reference operations for events, as shown in FIGS. 2A and 2B. In both models, functionality is divided between a presentation layer 200, an application layer 202, a domain layer 204, and an infrastructure layer 206. The CQRS further includes a data access and data transfer object (DTO) layer 208. FIG. 3 shows the devices and modules used to implement the functionality for bounded contexts described here according to the CQRS/ES model. FIG. 3 is segmented into the following: devices and modules for implementing queries provided to a client 322 over a communication network, which include database 316, third data layer 318, facade 320; devices and modules for processing commands from client 322 received over a communication network, which include command bus 324 and command handler 326; devices and modules for processing internal events in response to commands (either from the client or from external events), which include domain 304, repository 302, and event store; and devices and modules for processing external events (or publishing), which include event publisher 306, queue 310, event handler 312, and services 308. The work management, resources, and workflow functionality described in greater detail herein is implemented in hardware and software components consistent with the devices and modules and interconnections as shown in FIG. 3.

Project Creation Process

Using the system 100, a user is able to create a project object in the system. A user, such as a project manager or sales representative, accesses the system 100 through a GUI presented on the display of the user device. The server machine 102 provides the user with an interface and prompts the user to input information concerning a new project, including a description of the project, the type of project, the total labor force (in hours or days) needed for the project, the total cost for the project, the start date, and the deadline date. After a user enters certain information corresponding to the creation of a project, such as the type of project, the description of the project, or both, the server machine 102 calls the best practices engine to determine, based on the type of project and an analysis of the description of the project, tasks to complete the project and provides the proposed tasks to the user to confirm their use in the project. The user confirms that the tasks are correct or makes modifications to the tasks or portions thereof in accordance with the task creation process, whereupon the tasks are created in the system, assigned to resources, and monitored in accordance with the description herein.

As described in greater detail below, the server machine 102 determines a duration of each task in the project. The program control calculates an end date (or finish date) for the project based on the start date of the project plus the duration of each task, taking into account the business calendar. The program control 128 provides an alert to the user if the end date is greater than the deadline date or an internal baseline finish date.

Upon creation of a project the server machine also automatically chooses a project manager to supervise the project based on data stored in the database storage 104 regarding the characteristics of the project managers, including experience and current workload conditions. Project managers may also be selected based on information provide concerning client-based needs or requirements.

Task Creation Process

When the program control 128 in system 100 determines that a task is needed for a project, it creates a request for a user, such as a project manager, to create a task. A user with a request in the system to create tasks creates a task through the user device 108 through a GUI provided by the system 100 and displayed on the user device 108. The task when saved in GUI is stored in the database storage 104 with initial status information and details of the task. As shown in FIG. 8, the details of the task include the scope, effort and deadline among others, and the task's metadata. After the required information for the task has been entered, the program control 128 in system 100 creates the task and puts the saved task in the queue for the workflow engine 130. Depending on the status of the task, the workflow engine 130 reads the data from the behavior table 138 for from the workflow in the database storage 104 and defines the next step of the task, establishing the responsible resource, time to completion, metadata of the task needed to complete the task, and stores this information in the database storage 104.

As part of the task creation and workflow process, the system 100 retrieves and applies constraints and ensures that a task is not created in the system unless it meets the constraints. In a preferred embodiment, the constraints include the following: tasks are limited to between approximately four and forty hours in duration, and tasks are not started by the workflow engine 130 unless it is expected that it can be completed based on resource availability and task predecessors.

To start the task creation process, the user logs into the system and creates a task object using the GUI as shown in FIG. 7. The user confirms or enters initial information regarding the task, including the project that relates to the task, create a name for the task being scheduled, identify the relevant department or group that will do the task, identify particular relevant skills, assign a priority level for the task, and the particular expertise necessary to accomplish the task. Through the GUI presented on the user device 108, the server machine 102 prompts the user (in this case, the project manager) to enter in this initial task information. The system then prompts the user to enter a first estimation of the task duration and a delivery date consistent with timely project completion as agreed to with the client. The project manager is not responsible for determining what resource will perform the task or when it should be started, as these functions are performed automatically by the system. In addition, where the user inputs a priority level of low or standard, the task deadline is automatically be determined by the system based on, for example, overall resource constraints for the relevant department or group and other deadlines associated with the project.

After entering the initial task information, the project control 128 moves to the next step of obtaining information concerning the formal task scope and detailing exactly what has to be done to complete the task. According to a preferred embodiment, the system 100 calls the best practices engine 134 to search the database storage 104 for optimized parameters generated and stored by the machine learning engine. Using the initial task information (such as the project type or keywords therein), the best practices engine 134 searches for and identifies whether there exists optimized parameters concerning the task scope and/or the task steps, and, if so, displays such parameters on the GUI of the user device as recommended parameters. If the best practices engine 134 does not identify optimized parameters based on the initial task information, the best practices engine 134 will attempt identification of optimized parameters after the entry of additional information by the user concerning the task scope. Alternatively, at any time the user may utilize the GUI to call up the best practices “wizard” for the entry of the detailed task information, which causes the system to invoke the best practices engine 134 and provide optimized parameters for the action. The user is prompted to review the optimized parameters relating to the task scope and task steps and to fill in any missing information not provided by the best practices engine 134, before moving to the next step.

If the best practice engine 134 is unable to identify optimized parameters for a particular task, the user may be prompted to enter all required data concerning the formal task scope and detailing exactly what has to be done to complete the task. The information entered by the user may be used to seed the machine learning engine and may serve as a template of optimized parameters to be used by the best practices engine 134 for subsequent tasks that are identical or similar to the particular task. Alternatively, user may create such a template that includes portions or all of the details for particular types of tasks outside of the project creation process.

FIG. 8 shows an example of information associated with the creation of a particular task, As shown in FIG. 8, in an engineering structural design of a residential building, the user (project manager) is creating a scope for a task that is relocating two concrete columns that are interfering in the parking lot on the first floor and changing the beams 8 and 11 layout in the second floor to accommodate HVAC. When prompted by the system 100 to enter in this scope, the user enters the following items: get architectural design in the intranet (link here) and see exact places to rotate column 23 and 28: 1 hour; rotate columns 23 and 28 and analyze results in the calculation modeling: 3 hours; optimize calculation: 2 hours; generate blue prints: 2 hours; get architectural design in the intranet (link here) and see places to change beams 8 and 11: 0.50 hour; change beams 8 and 11 to accommodate HVAC and analyze results in the calculation modeling: 1.50 hours; optimize calculation: 1 hour; generate blue prints: 1 hour. These items must be set forth in an order that permits efficient and timely completion of the task. For each item identified, the system prompts the user to state the anticipated duration (in working hours) for completion of the item. The user must generally focus on creating items that have all the information necessary to complete the item available to the assignee, so that once the item is started the item and overall task can be completed on schedule. Preferably, to promote efficiency, the system 100 ensures that the user cannot create any item that requires more than 16 hours to complete. In other embodiments, the system may include other limits on the maximum duration for each item, such as 8 hours or 24 hours.

Once the list of items to be completed to accomplish the task is received by the system 100, the system 100 prompts the user to go through a checklist to ensure that all information necessary to complete each item of the task is available for use by the individual assignees of the items. For example, as shown in FIG. 8, the system prompts the user go through a checklist to ensure that the actual architectural design materials provide sufficient information to complete each item of the task, so that none of the resources assigned to a task must go looking for additional information to complete an item after starting the item.

After the user completes these steps and enters in this information, the system 100 sums the time necessary to complete each of the items of the task and determines the total expected time to complete the task. The system 100 then displays this information to the user, and prompts the user to re-evaluate the time he has allotted for each item of the task to insure that the user has not provided any time estimates for the individual items that are unreasonably long or short. The system 100 further prompts the user to re-evaluate whether the time to complete the entire task is reasonable so that the deadline agreed to with the client can be met. In the preferred embodiment, the system 100 does not allow task creation without setting deadlines for completion of the task and each item of the task. In particular, the system 100 checks to ensure that a deadline is set for completion of the task and of each item of the task and does not permit the user to proceed with creating the task unless such deadlines have been provided.

If the final duration of the task is longer than a particular threshold, then the system 100 divides the task to ensure that the task is under the given threshold. In the preferred embodiment, the threshold is 40 hours, although other thresholds may be given depending on the type of task. In the preferred embodiment, if the total calculated task is greater than 40 hours, the system divides the task approximately in half, and allows the user to review the items included in each new task, in order to determine whether it makes sense to move certain items to one new task or to the other, depending upon production efficiencies.

An example of the system 100 dividing a task is provided with reference to FIG. 8. In the example, a project manager is creating a task for doing the detailing design of a concrete structure of a residential building. Now he is creating the task for detailing the columns of the building. When prompted by the system, the project manager enters the following scope: get architectural and structural design in the intranet (https://www.abc.com/link1) and analyze basic design: 4 hours; edit automatically generated detailing design columns 1 to 40: 16 hours; edit automatically generated detailing design columns 41 to 80: 16 hours; review edited detailing design: 16 hours; generate blue prints: 8 hours. The total duration of these items is 60 hours. In this situation, the system 100 determines that the original task is in excess of the predetermined threshold of 40 hours, and system 100 therefore splits the original task into two tasks. The first task (Task 1) created from the original task is for items 1-3, and the second task (Task 2) is for items 4-5. The scope of these two sub-tasks becomes as follows:

Task 1:

get architectural and structural design in the intranet (https://www.abc.com/link1) and analyze basic design: 4 hours; edit automatically generated detailing design columns 1 to 40: 16 hours; edit automatically generated detailing design columns 41 to 80: 16 hours. The total duration of Task 1 is thus 36 hours.

Task 2:

review edited detailing design: 16 hours; generate blue prints: 8 hours. The total duration of Task 2 is thus 24 hours.

After dividing a task into one or more separate tasks (i.e., sub-tasks), the system 100 presents the separate tasks to the user for validation. The user can alter the items contained under each of the separate tasks if he believes a different arrangement is more desirable. In doing so, the system monitors such alterations to ensure that the resulting separate tasks remain between a minimum threshold and a maximum threshold (e.g., between approximately four hours (the minimum threshold) and 40 hours (the maximum threshold)). With reference to the above example, in reviewing the separate tasks generated by the system the project manager may decide to leave items 1 and 2 in the first task (totaling 20 hours) and move items 3 to 5 (totaling 40 hours) into the second task. As another example, if the duration of a task is less than the minimum threshold (e.g., 4 hours), it is particularly desirable to add additional items to the task or have the project manager do the task himself.

As an example, a project manager in an engineering firm attempts to create a task to analyze a change in a residential swimming pool in a system where the minimum threshold is four hours:get comments from architect:0.50 hour; analyze and express opinion about change in the level of swimming pool: 2.00 hours. The total duration is thus 2.50 hours. In this situation, the system 100 won't allow the project manager create this task and generates an alert, prompting the project manager to revise the scope of the task to meet the minimum threshold. In this instance, the project manager adds an additional item to the task: get comments from architect: 0.50 hour; analyze change in the level of swimming pool: 2.00 hours; and incorporate change in calculation and generate blueprint: 1.50 hour. Thus the total duration becomes 4.00 hours, which meets the minimum threshold.

The desirability of requiring tasks that are within a minimum and maximum threshold (for example, identifying tasks that have a duration of approximately four to forty hours), is to avoid inefficient micromanagement and macromanagement that sometimes leads to unfortunate surprises. However, it is possible and sometimes desirable to allow the system to accept less than approximately four hour tasks or longer than approximately 40 hours tasks. Accordingly, the system 100 may permit a user to override the minimum and maximum thresholds. In particular, if a user requires that a particular task be under the minimum threshold or over the maximum threshold, the system generates a request for approval of such variance and sends the variance to a user or group of users who have the ability to approve such variances. Upon receipt of approval, the system 100 will permit the task to proceed. In this manner, it is possible to override the system and approve specific tasks outside these limits.

If an item lacks information necessary to complete an item according to the checklist, the system 100 will prompt the user to indicate whether the user wants to perform the portions of the task that can be completed without the necessary information (i.e., whether to create partial task), or whether the user prefers to wait for the missing information to be provided. For example, and with reference to the prior example, when checking to ensure that all information for each item in a task has been provided, the system 100 determines that the project manager has not provided information about exactly which changes are needed in beams 8 and 11. In this situation, a portion of the task can be completed in the absence of this information, and as a result the system 100 prompts the project manager to indicate whether to create a partial task from the original task, where the partial task includes those items of the original task that can be completed based on the present information. In the present example, the project manager chooses not to proceed with a partial task, and to instead wait until the column information is available before proceeding with the task. As a result, the system 100 creates an external event for the missing beam information, and prompts the project manager to insert a follow up date for the missing information. Generation of the task is then contingent upon entry of the missing beam information.

Alternatively, the user may decide to proceed with a partial task based on the information that is available at that time. In this case, the system splits the original task into two separate tasks, with the first task having a scope that includes all items of the original task for which the necessary information has been provided—that is all items up to, but not including, the task for which the necessary information is missing—which represents the “split point” for the creation of the two separate tasks. In other words, the first sub-task has a scope that is the scope of the original task subdivided up the last item that has all the information to be completed. If the first items (up to the split point) have more than the minimum hours of duration (e.g., 4 hours of duration), the user can accept the split proposed by the system 100 and create the new separate task. For example, and again with reference to the prior example, if the project manager chooses to go forward with a partial task based on the information that is available at that time and to therefore create a “split” task, then the system generates a first sub-task whose scope includes the items up to the item for which the information is missing, as shown below: get architectural design in the intranet (link here) and see exact places to rotate column 23 and 28: 1 hour; rotate columns 23 and 28 and analyze results in the calculation modeling: 3 hours; optimize calculation: 2 hours; generate blue prints: 2 hours. The total duration of the first sub-task is 8 hours.

With respect to the remaining items from the original task (the first item with missing information and onward), the system creates an external event, and further creates a second, unallocated sub-task containing the remaining items where this second sub-task is associated with the external event (including the follow up date for the external event specified by the project manager). Once the missing information (and all other necessary information) is provided, the external event is marked off by the user in the system 100, whereupon the system 100 automatically and immediately places the second task straight into allocation.

For example, and again with reference to the prior example, if the project manager chooses to proceed with a split task, then the system generates a first sub-task as set forth in the prior example and a second sub-task (with an associated external event) as follows: get architectural design in the intranet (link here) and see places to change beams 8 and 11: 0.50 hour; change beams 8 and 11 allowing HVAC and analyze results in the calculation modeling: 1.50 hours; optimize calculation: 1 hours; generate blue prints: 1 hours. Thus the total duration for the second sub-task is 4 hours. The system further creates an external event for beams 8 and 11 information, along with a follow up (FUP) date. On the assigned follow up (FUP) date, the system 100 automatically creates a follow up task for the project manager to call the client and ask for the information needed. Once the information is received, the project manager enters the missing information into the system 100, whereupon the system 100 notes that the external event has been completed and immediately and automatically places the task into allocation.

For all tasks, the system automatically generates an associated tracking number. The system 100 allows a user to identify for a given task any other tasks (identified by their tracking numbers) that are the technical predecessors for that given task (meaning that the given task cannot or should not be initiated until the technical predecessors have been completed). The system 100 tracks the progress of technical predecessors for a given task and prevents the task from being initiated until all technical predecessors have been completed.

For example, when a project manager creates a task, the system 100 prompts the project manager to identify all tasks that are technical predecessors, whereby the allocation system prevents the task from starting until and unless its technical predecessors have been completed are done. For example, as shown in FIG. 11a, the project manager may be creating a task to design a logo for a new product. In this case, the project manager must first choose a name for the product. As a result, the project manager creates a first task for a naming expert to create a name for the product and then the project manager creates a second task for a designer to create the logo. In creating the tasks, the system 100 prompts the user to identify all technical predecessors, whereupon the user provides a response indicating that the second task can only be started after the first task has been finished by identifying the first task as a technical predecessor to the second task. When the allocation starts, the scheduler in the system 100 does not permit the second (logo) task to start before the first (naming) task is delivered, thereby recognizing the restriction that the logo cannot be created without the designer knowing what the name of the product is.

The program controller 128 in the system 100 activates the notification engine 132 to notify the user about new tasks assigned. The notification engine 132 reads new task status in the database storage 104, sends by email or other alert the new task alert to the resource and registers this in the database storage 104. When the user accesses the system in his device the program control 128 in the system 100 provides, in the GUI of the user device 108, a panel with new tasks and their information. When the resource finishes his task, the resource provides this information in the GUI of the user device 108, uploads related files, and submits the information and related files. The finished task is stored in the database storage 104 by the system 100 as well as the related files that are uploaded, with time and quality indicators summarized with existing data from the resource. The time and quality indicators are used to generate resource rankings by the program controller 128 in the system 100, as discussed in detail. The time and quality indicators, rankings, and all other generated information are further stored in the database storage 104. These indicators, team ranking, resource ranking, task panel by task status and related uploaded files from the task are also presented in the GUI of the user device 108 and the workflow continues the process.

Business intelligence (BI) analysis tools 110 are run in scheduled periods in the warehouse database 106 that stores the data. The warehouse database 106 generates consolidated data and forecasts over data stored during the complete task process workflow.

Task Allocation Process

After the task creation process is concluded, the system automatically starts the task allocation process. In this process, there are three core constraints recognized by the system 100: the system never assigns two tasks at the same time to a single person (in other words, each resources works on only one task at a time); the system assigns each task to a single professional; and no resource is to be assigned any task that is not in the schedule (in other words, no resources works on a task unless it has been scheduled).

In order to perform the task allocation process, the system receives the following information about each professional: username; practice area; level of expertise; and team. This professional information is stored in a database 104 in the system. This information is maintained for all resources in an organization, regardless of location. This allows the best resource for a particular project to be allocated regardless of data.

When a task is entered into the system, the system first analyzes the expertise required to complete the task. The system works with a novel data structure called an expertise matrix, as shown, for example, in FIG. 7. Each type of industry, practice area within an industry, and resource type may have its own expertise matrix based on the particular skills and levels of expertise in that particular area.

In a preferred embodiment, each expertise matrix has five levels of complexity (none, low, standard, high and expert) in one direction and skills in the other. Other levels of complexity may be used, depending on the amount of granularity required for adequately defining the complexity of expertise for a particular professional and/or for a particular industry. In addition, these skills will vary from industry to industry, and from each practice area inside the same industry. For example, if the particular industry is “production,” then one of the Practice Areas might be “machining,” with the associated skills being “aluminum trimming”, “copper trimming”, etc. Each resource in an organization firm is assigned to one or more practice areas, and for each available skill in that practice area the resource is associated with an expertise level. Once this information is entered and stored into the system 100, the task allocation process of the system 100 determines whether or not a task that is created can be serviced by a resource based on the level of expertise on one given skill the task demands and the level of expertise the resource possesses with respect to that particular skill.

The system 100 analyzes the level of expertise required for a particular task and generates a list of all possible resources. In the next step, the system 100 chooses the preferred resource for that task, based on the following guidelines: the resource shall have at least the level of skills needed; the resource shall be from the team that is involved in the project; the resource shall have completed the last task done in the project (assuming that this is not the first task of the project, in which case this guideline would not apply).

In addition, the system 100 chooses a preferred resource based on a number of additional factors. The system 100 prioritizes the resources from the team of that project and follows with all other possible resources for that task. In addition, if a resource has a skill level that is higher than needed for a particular task then that individual is always approved for that task; however, the system 100 prioritizes those resources with a lower (but sufficient) skill level, in order to develop the skills of the less-skilled resource. Another dimension used for prioritizing the individuals for selection of the preferred resource is cost, in that a cheaper resource is prioritized over a more expensive resource, all other considerations being the same. A significant guideline applied by the system 100 in the task allocation process is that no resource has two tasks at the same time.

If the preferred resource can deliver the task on the deadline, without changing the other deadlines from his other tasks, the system 100 allocates that resource to the task. If that resource cannot deliver the task on deadline without changing the deadlines from the resource's other tasks, then the system 100 suggests another resource, from the team and with the required skills, that can be allocated while respecting the deadline from this task and his other tasks. If the preferred resource cannot meet the specific deadline of the task, but can meet it within a specified grace period, then the system 100 accepts the delay and assigns the preferred resource to the task provided that the priority level of the task is low or standard. In a preferred embodiment, the grace period is one working day.

If the system 100 cannot identify a resource on the associated project team with all the required skills, and respecting all deadlines, the system 100 engages a task prioritization process in which the system 100 prioritizes tasks, postponing the deadlines in other tasks with smaller priority levels in order to meet the deadline of the present task.

The system 100 can also be configured to override the above preferred resource selection process and to automatically assign the same resource to a particular task in certain circumstances, such as, for example, assigning the same resource to all tasks for a particular project or assigning the same resource to all tasks for a particular client. This option is provided in order to take into account certain project realities or client demands. Although the system 100 has the flexibility to change the resource working on a particular task to take into account a preferred resource in a project gives, for certain complex projects changing the resource working on the project can result in inefficiencies and stress, including to the client. For example, a project or a client may have encountered a recent problem and that the project manager may wish to ensure that no further problems will arise by virtue of reassignment to a resource that may be less knowledgeable about the past problems with the project or client. As a result, the project manager can set the option in the system 100 to not change resources in a specific project or client.

Priority levels for a particular task are set in the system in four levels: low, standard, high, and urgent. The system 100 applies a quota system to each project manager to ensure that only a certain number or a certain percentage of tasks generated by the project manager can be at the higher levels for a particular period. In a preferred embodiment, the system 100 permits each project manager to assign a maximum of 10% of his tasks to the urgent priority level, and a maximum of 15% in high priority level for the rolling period taking into account the last 61 days.

The priority levels also affect the deadline for a particular task. For example, in a preferred embodiment, tasks with low priority levels cannot have a deadline shorter than the sum (in working days) of its duration plus 15 days. For tasks with a standard priority level, the task cannot have a deadline shorter than the sum of duration plus 10 days.

If there is a technical predecessor (other tasks assigned to another resource that must be completed before the current task can be started) to a new task, the system 100 requests that the project manager enter such technical predecessors (identified by their Tracking Numbers) at the time the particular task is created (as shown in Fig. [ ]). The system 100 operates to guarantee that the new task is started after the predecessor tasks are completed, optionally with a gap in between the completion of the predecessor tasks and the start of the new task.

In a preferred embodiment, the gap between the completion of the predecessor tasks and the start of the new task is one working day by default. The system 100 enforces this guarantee by continuously monitoring and checking the completion of the technical predecessor tasks by their tracking numbers. For each task that is created in the system, the system 100 generates a flag indicating that the task is completed. For a given task, the system 100 automatically and periodically checks to determine whether all technical predecessor tasks are completed and, if so, the system 100 releases the given task to allocation so that it can be started.

The system 100 also allows groups of interrelated tasks to be related as activities. Each activity is a group of tasks that are interrelated but that use different skills, usually from different practice areas. For each activity, the system 100 accepts a set of predefined rules of technical predecessors based on the particular activity. For example, for an activity with a naming task and a logo task, as in the above example, the naming task will necessarily need to precede the logo task. According to, and under the predefined rules for such activity, the naming task is automatically designated by the system 100 as a technical predecessor to the logo task such that the logo task cannot start before the naming task is scheduled to end.

The system 100 automatically adjusts deadlines for tasks that are interrelated within an activity. For example, if the naming task gets delayed, the system 100 automatically postpones the logo task in order to respect the predecessor rule. In a more specific example, if the naming task was originally scheduled to end on a Monday and the logo task was originally scheduled to start on the following Wednesday, but the naming task becomes delayed two days such that it is not finished until Wednesday, the system 100 automatically adjusts the starting day of the logo task to be at least two days later (i.e., the following Friday).

After taking into account the above considerations, the server machine 102 automatically creates a new task alert that contains information regarding the new task and sends the new task alert to a user device terminal 108 for viewing by another user, such as a production manager. The new task alert generated by the server machine 102 shows that a new task has been created, to whom it was allocated (confirming expertise level defined by project manager), when is it starting, its duration, its formal scope, and other relevant details as shown in FIG. 10.

In connection with the allocation process, the system 100 periodically analyzes the current allocation of tasks to resources to determine whether there are any inefficiencies, such as a resource that lacks sufficient allocation of tasks. In a preferred embodiment, every day the system 100 searches the current allocation to determine if any resource has no tasks assigned for the next three working days. Alternatively, the system 100 could flag any resource that lacks any tasks within another period of days (or hours), as set by the user. A lack of allocated tasks for a resource can happen for several reasons, such as a lack of tasks (the obvious reason), because a technical predecessor (from another resource) is not being competed thus creating a gap in the current resource's schedule, or even because another resource was without tasks that resulted in reassigning tasks from the current resource to the other resource. Knowing about such inefficient allocations and the reasons behind them in advance helps the system to prioritize the allocation of resources, which may include decreasing the allocation for the over utilized resource in order to give that resource needed rest, or prompting project managers to create tasks for underutilized resources.

Because the system monitors the schedule of all resources, including the chronological order of all tasks assigned to a resource (i.e., what task the resource is currently working on as well as what task or tasks are in the allocation queue for the resource), the system automatically generates and sends alerts to users, such as production managers, with the names of resources and the possible gaps in their schedules. The alerts allow the project managers and production managers to not only be aware of such gaps, but also to manually interact with the system 100 via server machine 102 to reassign tasks in order to address such inefficiencies. Regardless of such manual interactions, the system 100 automatically attempts to address gaps in the schedules of resources by prioritizing the resource as an available resource for purposes of allocating new tasks. In this way, the system 100 works to achieve 100% allocation for a production team.

The system 100 prevents changes to schedules on the same day (D₀). In a preferred embodiment, the system 100 also prevents changes to schedules on the next working day (D₀₊₁). The system 100 permits only users with sufficient access privileges and rights, such as top management, to override these restrictions and to make changes to schedules on D₀. Unlike the creation and allocation of tasks in other systems, in this case the project manager is the only one that can create a task in the present system, and each such task must undergo the entire process of creation and allocation, wherein the shortest time to start is the next working day.

The system 100 ensures that all scheduling is transparent to the resource, such that the resource is only performing one task at a time. The system 100 tracks and displays the changes from one project/engagement for each resource (as illustrated in FIG. 12) and in the schedule for D₀₊₁, allowing the resources and managers to analyze such changes as a key performance indicator (KPI) as compared to other members of a project team in order to ensure consistency in this respect.

The system 100 also tracks total allocation through the use of two variables: number of days already allocated for each team, and total allocation for each week for the some upcoming number of weeks. In a preferred embodiment, the number of upcoming weeks is eight. The number of days already allocated for a team is calculated by summing all days already on the schedule for a team and dividing by the number of resources in the team, resulting in the mean number of days allocated per team member. Other measures may be calculated in lieu of or in addition to the mean, such as the median or the simple mean between the mean and median (i.e., the “Mode's Hope”). For example, if a team with five resources has 6, 8, 10, 12 and 20 days allocated to those resources, respectively, the mean is 11.2 days already allocated, the median is 10 days already allocated and the Mode's Hope is 10.6 days already allocated.

The system 100 automatically send alerts to every resource to whom is assigned a new task, by generating an alert that includes all of (or relevant portions of) the task information and sending the alert with the task information to the user device 108 of the resource.

Task Performance Process

After the allocation process for a task is completed, the system undertakes a Performance Process with respect to that task, as described herein.

One day before a given task starts, the server machine 102 automatically sends the production manager an upcoming task alert. The alert prompts the production manager to recheck the task, analyze its scope, ensure that what has to be done in the task is clear, and ensure that all required information for the task is available. The upcoming task alert contains all the information needed for the production manager to perform this check, and includes the information shown in the alert in FIG. 12. This upcoming task alert contains all the information needed for the manager to confirm the upcoming launch of the new task.

Upon receiving the automatic upcoming task alert from the system (the day before the task is to start), the production manager is prompted to call for a meeting with the resources responsible for the tasks starting the next day, one at a time, to formally present the task in detail and to discuss it with the resource, setting and agreeing on dates, durations, etc.

Thereafter, the system 100 continues to send to each production manager an automatic “tasks starting tomorrow” alert showing all of the tasks that are planned to start the following day, including the task number, the duration, the project name, the description, and the professional, as shown in FIG. 12. Typically, a production manager deals with more than one project and resource at a time, so that there can be more than one task starting the next day, from the same project or from different projects. Once the production manager receives this alert, he or she knows who he or she must call to present the task that will start the next working day. The tasks starting tomorrow alert is also useful for the production manager to schedule and manage his or her own day. In addition, the tasks starting tomorrow alert may include all projects that are ending on the day it is received, in addition to displaying the tasks starting the following day, to better allow a production manager to plan and manage his or her day.

If the production manager thinks the duration for the task has to be changed, the production manager may submit a change request (more time or less time) to the system 100 and the system 100 will adjust the deadline for that task and make any necessary adjustments for related tasks and any necessary adjustments to the schedule of the professional. The production manager can also change the order of items. Every day the system only allows task duration change requests until a particular time (such as 2 pm). At that point, the system stops accepting change requests for some time and adjusts the schedules and deadlines for affected professionals and related tasks.

Another key benefit from the present system is that no resource on a production team performs a task that is not in the schedule. In this way the system 100 ensures that it is not possible for a project manager to ask for more than is actually within the scope of a task, or ask for performance of another task that simply cannot occur because other tasks have not yet been completed. The system 100 ensures that every task is performed according to a schedule, and each task is created according to the rules implemented by the system.

The server machine 102 automatically delivers tasks to the resource via notifications to the user device or directly to the resource itself, and the resource is presented the scope of the new task the day before the start of the task. The resource then performs the task and, at the end of the task, the resource logs into the system to formally mark the task as completed. In connection with this completion process, the resource uploads into the system all documents generated by the professional in accordance with the scope of the task. This completion process and the uploading of any documents into the system 100 triggers the server machine 102 to generate a quality assurance task for the associated production manager so that the production manager can validate what has been done, ensuring that the work is technically sound and that the entire scope of the task has been completed. For the quality assurance task the system 100 generates a checklist, sent automatically to the production manager by the system 100, that lists all the items of the scope of task that should have been completed. The system 100 prompts the manager to evaluate the technical results and aspects of all items in the scope of the task. Because each field of professional services has its own relevant quality assurances, the system 100 allows for each user to set the particulars of the checklist (including the specific aspects, points and parameters) for the review in connection with the quality assurance process. In addition, the level of the quality assurance tasks can be set differently according to the complexity of the project or the difficulty of the task itself. Once these specific parameters have been set, for each task considered complete the system will trigger, through workflows assigned to the production manager, the quality assurance tasks chosen by the user. In addition, it is possible to configure the system 100 such that it does not generate any quality assurance tasks for certain completed tasks.

If the production manager detects any mistakes in the finished task, the production manager enters into the system the necessary corrections, whereupon the system 100 returns the task to the resource, demanding those corrections. Once the resource has made the corrections and re-mark the task as completed (including reinserting/uploading any corrected or additional documents) in the system, the system operates such that the workflow of the task returns back to the production manager by sending an updated quality assurance task to the production manager for another, final review.

For example, and with reference to the prior example, after the resource marks the columns task completed, the system 100 creates a quality assurance task for the production manager. The quality assurance task generated by the system requests that the manager check the changes in columns 23 and 28 calculation in detail. If the production manager perceives something wrong or missing (for example column 28 had a wrong calculation parameter), the production manager will enter the specific error into the system 100, whereupon the system 100 will re-open and return the task to the engineer for correction. After correcting the errors the engineer resource will again mark the task as completed in the system 100, whereupon the system 100 operates to return the workflow of the task back to the production manager. The production manager then reviews the updated work to confirm that the error has been corrected, and marks the task as reviewed and verified in the system 100, whereupon the system 100 closes the task. In the exemplary system 100, nobody can delete workflows for task creation or quality assurance.

The system 100 also permits the option of having a separate quality assurance team or peer review; however, no task may undergo a quality assurance team review prior to the formal approval of the project manager. There is a possibility of setting the system for randomly choosing quality assurance tasks. Another variation is having the project manager and production manager role being done by the same person. It is also possible to have another individual in charge of reviewing and adjusting schedules online for a project team, a business unit or the entire company.

After completion of a task, system 100 automatically makes updates to the expertise matrix of the resource or resources involved in completing the task. In particular, system 100 updates the expertise level of the resource based on the difficulty of the task. For example, if a resource has completed a certain number of tasks at a given difficulty level (e.g., at the “high” level), and has received positive quality reviews for such work and/or has done such work without requiring additional correction, the system 100 will update the expertise matrix by increasing the expertise level for that resource (e.g., by identifying the resource as now being at the “expert” level).

Rewarding Process

The system 100 tracks all tasks, comparing the estimated duration to the actual duration for completing a task. The system 100 also knows who performed each task and knows the result of quality assurance process. Because the system 100 only permits a single individual to perform each task, the system 100 is able to create objective performance indicators that provide for meritocratic culture of rewarding and promoting individuals.

The system 100 uses the performance data to calculate several basic KPIs on which to base a rewarding process: (1) the number of days (or hours, or weeks, or any other time units) ahead of schedule (DAOS); (2) a quality ponderation (QP) indicator (further discussed below). The system 100 also collects and uses a feedback (FB) indicator. The two first indicators (DAOS and QP) are automatically calculated by the system 100 based on objective criteria measured by the system in connection with managing the task generation, allocation, scheduling and quality assurance workflows. The third indicator (FB) on the other hand, reflects the personal judgment of the commitment of the resource to the culture of the firm, his growth in the period, his willingness to help colleagues, etc. Usually, the weight of the FB indicators is smaller than the weight of the other automatic KPIs, but the weights can be set by each user at the installation of the system 100 and changed thereafter.

Every day at 5 am (or any other time chosen by the user) the system 100 checks to determine if there are tasks that should have been finished the day before and were not. These delayed tasks are marked as delayed, such as by a red circle, in a task completion dashboard, as shown in Fig. [ ], which may be sent to the GUIs of user devices for production managers and/or project managers. The tasks already considered finished by the resource, but not yet checked by the manager are marked accordingly, such as by yellow circles. All other tasks that are due to be delivered in the days ahead are marked accordingly, such as by green circles.

Comparing results in a ranking, instead of creating goals to the production team, is a fair means for evaluating resources that stimulates healthy competition and helps to achieve a meritocratic comparison of performances. Another benefit of the system is that, by just comparing the completion rate of resources, the duration of each task is less important, as everyone is compared to a benchmark. Theoretically the durations could all be set as, for example, one day, and the results would be the same when comparing to a position in the ranking, because any mistakes would be equally distributed along the resources in the course of the period of evaluation.

By combining results on both rankings, the system 100 creates a final online ranking, as shown in FIG. 14. The final online ranking may be used to determine resource bonus or compensation. The system generates and sends to resource up-to-date rankings for resources. The availability of the ranking to resources gives them real-time feedback about their performance.

The system 100 builds the rankings in the same manner regardless of what is being compared thru the ranking. In a preferred embodiment, the system 100 works by directly comparing performances of individuals, and assigns a grade 1.0 to the people in the median, i.e., the middle value in a distribution above and below which lie an equal number of values. The system 100 assigns to all the resources with a position above the median (with a better performance than the ones in the median) a value larger than 1.0 and assigns to all the resources situated in the ranking below the median (with a poorer performance than the ones in the median) a value smaller than 1.0. The user can configure in the system 100 the rule to define automatically the distribution of the grades among the resources above and below the median. For instance, the resource with the higher position in the ranking may receive a grade 2.5 (for example) and the grades are distributed linearly by the system between 2.5 and 1.0 (standard grade for the ones in the median) for all resources better positioned than the ones in the median and below the #1 ranked resource. Another possibility is to choose an exponential function to perform this distribution of grades, or any other mathematical variation.

The system generates two primary KPIs for each professional, one for speed and one for quality:

Number of Days Ahead of Schedule (DAOS):

This indicator is the primary indicator for evaluating and ranking resources. Accordingly, in a preferred embodiment this indicator accounts for 50% of the weight of the final ranking. The calculation of the DAOS KPI can be shown through example, where a resource has a 3 day task that is completed in 2 days. The system 100 records this completion as being 1 day ahead of schedule (3−2=1). Then the resource's next task is a 5 day task and the resource completes the task in 3 days. The system records this completion as an additional 2 days ahead of schedule (5−3=2). Because the professional was one day ahead of schedule because of his first task and was 2 mores days ahead of schedule, the system maintains the resource's current DAOS indicator as being a total of 3 days ahead of schedule. To continue the example, the resource's next task is a 3 day task, but the resource takes 4 days to complete the task. The system 100 records this completion as being 1 day behind schedule for that particular task. Because the DAOS indicator for the professional was 3 days ahead of schedule, but the resource completed a task one day behind schedule, the system 100 reduces the resource's DOAS indicator by 1 day such that the DOAS indicator for the resource is 2 days ahead of schedule. The methodology employed by the system 100 allows the creation of an online ranking that will keep tracking and comparing the number of days ahead of schedule of each resource in a team (or practice area). This number will set their position in the rankings.

Quality Ponderation (QP):

Alongside with a KPI measuring speed and the efficiency of the work, the system 100 generates a KPI linked directly to the quality of the work. In this way the system discourages resources from doing the work quickly without paying the necessary attention to the correctness and presentation of the tasks. To provide this counterbalance, the system 100 tracks the percentage of tasks without any mistakes (technical, scope or system compliance) arising from managerial review or from the items that must be completed and filed in the system (e.g., the time limit for duration change request). The system 100 tracks this QP indicator for each professional and then factors this QP indicator into the final ranking for comparing professionals.

Feedback (FB):

This item of evaluation acts as the final input for the finalization of the ranking by the system 100. The system 100 allows for the user to select the way to create the FB indicator. It can be done by giving a position in the ranking straight from a list of the professionals to be evaluated, using the same logic as the others KPI—i.e., choosing one professional to be the median (KPI=1.0) and grouping half of the others (which the manager thinks performed better than the one in the median) atop of the median and with KPI greater than 1.0 and the other half below the median with KPI smaller than 1.0. The system 100 provides a way to generate the FB inputting for each professional grades to selected aspects of his performance in the job (willingness to learn, overall commitment, etc.) and then calculating an individual score with this grades. After the individual grades are calculated, the system 100 applies the same logic again, giving a KPI of 1.0 to the ones in the median, KPIs greater than one for those with greater grades and KPIs smaller than 1.0 to those with grades below the median. The maximum and the minimum KPIs and their distribution can be set by the user upon the configuration of the system and can be changed at any moment. The manager can also perform a sanity check at the end and make any necessary adjustments, as this is the only KPI that should be subjective.

Automatic Project/Task Status Assessment Through Remote Image Analysis

The system 100 also allows for automatic assessment of project or task completion through the use of monitoring devices 116, such as digital cameras. These monitoring devices 116 may be remotely located from the rest of system 100. As disclosed below, this concept is most useful in the context of analyzing the progress of engineering projects based on visualization software. The first concept is the consideration of the time since the start of construction works (TSC), which can be different in the design period, where this time is estimated (ETSC) and in the actual construction (ATSC). This is the time when the actual photo (Actual Image) should be taken to make the comparison with the expected situation generated by the design (Virtual Image).

If a camera is set at a point defined by its three coordinates (x, y and z) and the three angles with respect to the X, Y and Z axes (α, β, γ), it is possible to bi-univocally store this image as ACTUAL_IMAGE (x, y, z, α, β, γ, ATSC). The number of images to be compared is arbitrarily defined by the owner or general manager, being defined as NIC, number of Images to be compared.

Being the expected stages of construction defined by the owner or general manager, software like Revit, Bentley, Nemetscheck and others can integrate this information with the design and produce images at any estimated time of construction from any point of view and store it as VIRTUAL_IMAGE (x, y, z, α, β, γ, ETSC). At each VIRTUAL_IMAGE (x, y, z, α, β, γ, ETSC), the owner or general manager defines the n objects (elements) that are to be compared by the system with the ACTUAL_IMAGE (x, y, z, α, β, γ, ATSC).

For each of these points of comparison the system automatically calculates an INDEX (x, y, z, α, β, γ, ATSC) adding 1 to each object in the VIRTUAL_IMAGE (x, y, z, α, β, γ, ETSC) that can be identified in the ACTUAL_IMAGE (x, y, z, α, β, γ, ATSC), The value of this INDEX (x, y, z, α, β, γ, ATSC) will vary between 0 and n.

The system allows for adjustments in ATSC and ETSC to take into consideration changes in the schedule of the project. The system automatically computes the OVERALL_INDEX (ATSC) by adding all the INDEX (x, y, z, α, β, γ, ATSC) for the NIC images defined above. The greater the OVERALL_INDEX (ATSC), the more the construction work goes as planned.

The system automatically produces a report with the evolution of the indexes, both at each of the NIC points as for the OVERALL_INDEX, allowing the project manager to immediately take appropriate measures to correct any anomaly.

If it is desired, it is possible to divide the objects (elements) to be compared into classes allowing for the automatic determination of which class of objects are more prone to present an error. The system will send an automatic message to the owner, to the manager and to the contractor urging them to pay more attention to these elements during the construction work.

While the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

We claim:

1. A computer program product embodied on a computer readable medium for processing project management information comprising:
computer code for receiving from a plurality of sources a plurality of project data records;
computer code for creating a set of tasks based on information contained in said project data records;
computer code for determining a plurality of characteristics of a plurality of resources;
computer code for correlating the set of tasks with the characteristics of said resources; and
computer code for allocating a plurality of tasks from the set of tasks to the resources based on the characteristics of said resources.

2. The computer program product of claim 1, further comprising computer code for assigning a single task from the plurality of tasks allocated to a single resource from said resources.

3. The computer program product of claim 1, further comprising computer code for restricting a single resource from said resources from performing a task based on a predetermined condition.

4. The computer program product of claim 1, further comprising computer code for automatically updating the plurality of characteristics of a resource based on the performance of said resource in a completing a task within the set of tasks.

5. The computer program product of claim 1, further comprising computer code for receiving an image processing file from a three dimensional camera.

6. The computer program product of claim 5, further comprising computer code for updating the status of a task within the set of tasks based on receiving said image processing file.

7. The computer program product of claim 1, further comprising computer code for generating a new project data record based on the completion of the set of tasks by said resources.

8. The computer program product of claim 7, further comprising computer code for storing the new project data record with said plurality of project data records.

9. The computer program product of claim 8, further comprising computer code for generating predictive analytics for a future project based on the plurality of project data records, the new project data record, and characteristics of said resources.

10. The computer program product of claim 1, further comprising computer code for determining the need to retain or remove said resources or the need to acquire one or more new resources based on said set of tasks and characteristics of said resources.

11. The computer program product of claim 1, further comprising computer code for automatically updating the status of a project based on the performance of a resource from said resources in a completing a task from the set of tasks.

12. The computer program product of claim 1, further comprising computer code for generating notifications to said resources when a resource completes a task from the set of tasks.

13. The computer program product of claim 1, further comprising computer code for generating rankings for said resources based on the characteristics of said resources.

14. A project management system for efficient management of workflow data among resources in one or more networks built on top of an underlying network, wherein the workflow data includes a plurality of projects and wherein the plurality of projects includes a plurality of tasks, the project management system comprising:
a memory that stores (i) a plurality of project data records, and (ii) a plurality of characteristics of a plurality of resources;
a project divider that separates a project into a set of tasks based on said project data records and the characteristics of said resources;
a performance tracker that generates metrics from network traffic along the one or more overlay networks, including the completion of one or more tasks from the set of tasks in the project;
a learning engine that continuously quantifies the characteristics of the resources based upon an analysis of the metrics; and
a feedback loop that (i) generates a new project data record when the project is completed, (ii) stores said new project data record in said memory, and (iii) dynamically updates the characteristics of said resources.

15. The project management system of claim 14, wherein the project divider assigns a single task from the set of tasks to a single resource within said resources.

16. The project management system of claim 14, wherein the project divider restricts a single resource within said resources from performing a task based on a predetermined condition.

17. The project management system of claim 14, wherein a three dimensional camera attached to the one or more overlay networks provides further metrics to the performance tracker.

18. The project management system of claim 14, wherein the learning engine generates predictive analytics for future projects based on the project data records, the new project data record, and characteristics of said resources including the need to retain or remove said resources or the need to acquire one or more new resources.

19. The project management system of claim 14, wherein the performance tracker generates notifications to the resources when a resource within said resources completes a task from the set of tasks.

20. The project management system of claim 14, wherein the learning engine generates rankings for said resources based on the characteristics of said resources.

21. A system useful in a project manager planning projects by efficiently managing work flow of a business, the system comprising:
a cloud based database containing data, for each of a plurality of project data files, defining a plurality of tasks corresponding to the plurality of project data files, wherein each of the project data files includes a plurality of characteristics of a plurality of resources used to complete a project;
a network enabled device for sending data, for each of a second plurality of resources, reporting on the status of a second plurality of tasks within a second project; and
a computer server at the project manager, which computer server is coupled to the network enabled device and the cloud based database and programmed to:
receive from the cloud based database the project data files;
automatically allocate the second plurality of tasks to the second plurality of resources based on the project data files and a plurality of characteristics of the second plurality of resources;
receive from the network enabled device, the status of the second plurality of tasks within the second project; and
in response to the status of the second plurality of tasks being complete, automatically generate and transmit to the cloud based database a new project data file for the second project.

22. A system comprising:
a project management component comprising at least one hardware processor and configured to:
automatically obtain a request for a project to be implemented;
automatically define the project into a one or more tasks based, at least in part, on information from a different project, wherein the different project includes characteristic data of one or more resources;
automatically determine a task allocation based on task requirements for the project, wherein the task requirements includes a deadline for task completion;
automatically determine a period of time associated with the execution of the task by available production time of one or more resources, wherein the period of time is calculated for each available resource and is based, at least in part, on a current utilization of the available resource in relation to the remaining capacity of the available production time;
exclude available resources when the determined period of time exceeds the deadline for task completion;
automatically select a resource of the one or more resources based, at least in part on the task allocation and the period of time associated with the task;
automatically cause the task to be implemented by the selected resource.

23. A system for determining an optimized sequence of workflow by a first resource to a plurality of tasks:
a non-transitory computer-readable storage medium;
a processor configured by executing one or more software modules including instructions in the form of code stored in the storage medium, the modules including:
a communication module that configures the processor to receive over a network from a remote device associated with the first resource, a plurality of task requirements to be completed by the first resource;
a database module that configures the processor to store the plurality of task requirements to the storage medium, and wherein the database module further configures the processor to access a database including resource characteristics associated with a plurality of resources and a database including project data;
a modeling module that configures the processor to generate one or more models for predicting resource performance for each of the plurality of task requirements using the resource characteristics associated with a plurality of resources and the project data;
an analysis module that configures the processor to generate one or more ordered sequences of tasks to be completed by the first resource, wherein each of the one or more ordered sequences begins with the first resources' start time, ends with the first resource's end time, includes at least a portion of the plurality of task requirements, and wherein consecutive tasks in an ordered sequence define the availability of the first resource,
wherein the analysis module further configures the processor to calculate a total duration for each of the one or more ordered sequences, wherein the total duration is calculated using the one or more models in view of the start time, and in view of the availability of the first resource as determined from a database of project data, and
wherein the analysis module further configures the processor to identify based on the calculated total durations, an optimal ordered sequence from among the one or more ordered sequences, wherein the optimal ordered sequence has the lowest calculated total duration; and
wherein the communication module further configures the processor to provide over a network to the remote device associated with the first resource, the optimal ordered sequence.
